(19) United States
(12) Patent Application Publication
(10) Pub. No.: US 2016/0172872 A1
(43) Pub. Date: Jun. 16, 2016

(54) BATTERY CHARGING APPARATUS USING ULTRA CAPACITOR

(71) Applicant: VOLTA, Busan (KR)

(72) Inventor: BYEONG-GHIL CHANG, Incheon (KR)

(21) Appl. No.: 14/566,187

(22) Filed: Dec. 10, 2014

(51) Int. Cl. H02J 7/00; B60L 11/18

(52) U.S. Cl. CPC H02J 7/007; B60L 11/1809; B60L 2230/32

(57) ABSTRACT

The present invention relates to a battery charging apparatus using ultra-capacitor, which helps achieve longer battery life while applying the high-speed charging. The present invention offers a battery charging apparatus using ultra capacitor with the electric current control method to prevent performance failure of a battery while maximizing the battery life. Also, the present invention offers a battery charging apparatus using ultra capacitor to minimize the time for a car to stay at the charging station by progressively discharging and simultaneously charging multiple ultra-capacitors. Also, the present invention offers a battery charging apparatus using ultra capacitor to maximize the voltage capacity at voltage boosting section by utilizing plug hand tap method.

### TECHNICAL FIELD

The present invention relates to a battery charging apparatus. More specifically, the present invention relates to a battery charging apparatus using ultra capacitor.

### BACKGROUND ART

A battery-charged electric car is developed and commercialized in earnest with the exhaustion of the fossil fuel. However, unlike common automobiles using fossil fuel (gasoline, diesel etc.), an electrical car needs a longer time required to charge a battery.

In other words, 4 to 10 hours are required to charge a battery with the general charging method, and at least 30 minutes are required even with the high-speed charging method. Particularly, the high-speed charging method shortens a battery life because of the chemical characteristics of the battery. This is applied equally to batteries for the motor-operated forklift, which have both the general charging method and the high-speed charging method. In this regard, the general charging method include the constant current charging mode, charging the constant current until the voltage reaches to the certain level, constant potential charging mode, charging the constant voltage until the current decreases to the certain level, and the equalizing charging mode, charging for the designated time with the small current. Also, the high-speed charging method includes the high current charging mode, where the battery is charged with the constant current during the configured charging time.

The high-speed charging method may cause various technical problems. First, performance and life of a battery decrease when high-speed charging is performed continuously. Second, the battery is destroyed due to the overvoltage when the fully charged battery is over charged in high-speed charging mode. Third, a battery is not fully charged with the high-speed charging mode when the battery is completely dead. Fourth, the battery is overheated and destroyed when charged with the high-speed charging mode right after being fully charged with the high-speed charging mode.

Meanwhile, charging method used by charging apparatus for motor-operated forklift, the patent publication No. 2012-0072788, includes a battery charging apparatus including three-phase rectifying diode, which converts AC power to DC power and transformer primarily converts high-voltage AC power to low-voltage three-phase AC power by being connected through a connector from outside three-phase AC input method; a charger including super-capacitor and battery charged by electric current supply and charging voltage from a battery charging apparatus by switching the power of battery charging apparatus; a control apparatus including DC/DC converter converting the voltage in order to supply charged voltage and current to the power of various electric load; the first step restricting the number of continuous charging counts by counting for the operation of the high-speed charging method; the second step converted to the general charging method when the charging voltage exceeds the standard voltage during the high-speed charging of the battery; and the third step converted to the general charging method when charging is not completed after the high-speed charging of the battery. When the counting value is smaller than random standard counting number, high-current charging mode is proceeded, while general charging mode is proceeded when the counting value is larger than the random standard counting number.

However, aforementioned charging method is not applicable to the situation when the charging process should be promptly completed, because this method compulsively converting the high-speed charging mode to the general charging mode after the high-speed charging mode is continuously run for several times.

### PRIOR ART DOCUMENTS

### Patent Documents

(Patent Document 001) Patent Publication No. 2012-0072788, a charger for motor-operated forklift

### SUMMARY OF INVENTION

### Technical Problem

The present invention offers a battery charging apparatus using ultra capacitor to help achieve a longer battery life while applying the high-speed charging.

Also, the present invention offers a battery charging apparatus using ultra capacitor with the electric current control method to prevent performance failure of a battery while maximizing the battery life.

Also, the present invention offers a battery charging apparatus using ultra capacitor to minimize the time for a car to stay at the charging station by progressively discharging and simultaneously charging multiple ultra-capacitors.

Also, the present invention offers a battery charging apparatus using ultra capacitor to maximize the voltage capacity at voltage boosting section by utilizing plug hand tap method.

### Solution to Problem

A battery charging apparatus of the present invention includes a high-speed charging switch section for high-speed charging; an ultra-capacitor of parallel connection with aforementioned high-speed charging switch section; a low-speed charging switch section of parallel connection with aforementioned ultra-capacitor; and a low-speed charging section of parallel connection with aforementioned the low-speed charging switch section.

Aforementioned battery charging apparatus of the present invention preferably includes a voltage boosting section, which boosts three-phase prevailed voltage to fixed voltage; and a rectifying section, which rectifies AC voltage exported from aforementioned voltage boosting section into fixed level of DC voltage.

Aforementioned high-speed charging switch section preferably includes multiple high-speed charging switches, being on/off simultaneously or progressively.

Aforementioned multiple high-speed charging switches are preferably turned off when the ultra-capacitor is fully charged.

Aforementioned low-speed charging switch section includes multiple low-speed charging switches. Aforementioned switches are same in the number with the high-speed charging switches. The low-speed charging switches are selectively switched.

Aforementioned charging current control section includes low-speed charging voltage detecting element of parallel connection with aforementioned low-speed charging section; a switching element placed between aforementioned low-speed charging switch section and low-speed charging section; a battery charging voltage authorized to aforementioned low-speed charging voltage detecting element; a comparator comparing the standard voltage with the battery charging voltage received to the low-speed charging voltage detecting element; and a control switching element, which switches by the output of aforementioned comparator. Aforementioned switching element is controlled by the output of aforementioned control switching element.

Aforementioned switching element is one of IGBT, FET, BJT or IGBT with parallel connection, FET with parallel connection, BJT with parallel connection.

Aforementioned low-speed charging voltage detecting element preferably includes more positive temperature coefficients.

### Beneficial Effects

Beneficial effects that the present invention is expected to produce are as follows: the present invention allows maximization of battery life without performance failure from the use of high-speed charging method. The present invention minimizes time for a car to stay at charging station by simultaneously charging and progressively discharging multiple ultra-capacitors, while maximizing the voltage boosting capacity using plug hand tap method. The charging time only takes a few seconds (3-15 seconds). In other words, the present invention slowly charges a battery form ultra-capacitor that is charged in the shortest time, using voltage and current control circuit.

### BRIEF DESCRIPTION OF DRAWINGS

FIG. 1 is a circuit diagram of the battery charging apparatus according to the embodiment 1 of the present invention.

FIG. 2 is a detailed circuit diagram of the battery charging apparatus according to the embodiment 2 of the present invention.

FIG. 3 is a detailed circuit diagram of the battery charging apparatus according to the embodiment 3 of the present invention.

### BEST MODE FOR CARRYING OUT THE INVENTION

The present invention is described in connection with what is presently considered to be practical exemplary embodiments on reference to the below drawings attached. Prior to this, term used in this specification and claims should not be limited to be interpreted as an accepted meaning, but they should be interpreted with the meaning and concept in accordance with the technical idea of the present invention. Therefore, embodiments described in this specification and drawings are only the most preferred embodiments of the present invention and not representing all technical idea of the present invention, allowing various other equivalents to substitute the embodiments presented in this specification.

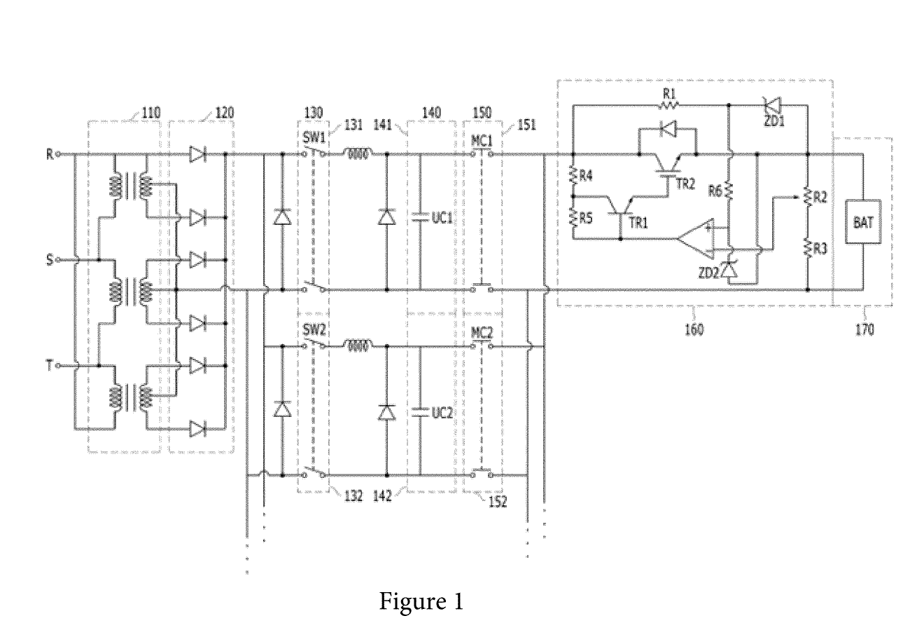

FIG. 1 is an overall circuit diagram of the battery charging apparatus according to the embodiment 1 of the present invention, including a voltage boosting section (110), a rectifying section (120), a high-speed charging switch section (130), a high-speed charging section (140), a low-speed charging switch section (150), a charging current control section (160), a low-speed charging section (170).

The voltage boosting section (110) receives three-phase prevailing voltage and boosts it to fixed voltage. For example, 220 volt is received and boosted to 800 volt.

The rectifying section (120) rectifies AC voltage boosted to 800 volt as DC voltage pivoting around the center tap.

The high-speed charging switch section (130) includes multiple mechanical high-speed charging switches (131, 132 . . . ), opening or closing simultaneously. In other words, the high-speed charging switch section (130) charges an ultra-capacitor by simultaneously or progressively closing multiple mechanical high-speed charging switches. When the ultra-capacitor is fully charged, multiple mechanical high-speed charging switches are simultaneously or progressively opened.

The high-speed switch section (140) includes ultra-capacitors in parallel connection with the end of the mechanical high-speed charging switch. The ultra-capacitor has a capacity to hold multiple farads (F) unlike a common capacitor.

The low-speed switch section (150) has parallel connection with the end of the high-speed switch section (140), selectively opened or closed. The low-speed charging section (170) is charged by selectively closing the low-speed charging switch section (150) with the high-speed charging switch section (130) opened.

The charging current control section (160) includes a comparator (comp.) that compares Zener voltage accepted by the Zener diode (VZD1, VZD2) while receiving battery charging voltage accepted by the battery charging voltage detecting section (variable resistance, R2); control switching element (TR1), which switches accordingly with the output of the comparator; and a switching element (TR2, IGBT), placed in the middle of the high-speed charging section (140) and the low-speed charging section (170), controlled by the output of the control switching element (TR1). By adjusting the variable resistance (R2), the size of current passing through the switching element (TR2) is controllable.

Meanwhile, according to the other embodiment of the present invention, a switching element (TR2) is replaceable with the FET or BJT instead of IGBT. Also, according to another embodiment of the present invention, a switching element (TR2) is replaceable with the IGBT of parallel connection, FET of parallel connection, and BJT of parallel connection in order to enhance the size of the passing-through electric current.

Lithium ion battery, lithium phosphorous iron battery, nickel hydrogen battery, or nickel cadmium battery is used for the battery of the low-speed charging section (170).

The following describes an operation of the battery charging apparatus, according to the embodiment 1 of the present invention.

First of all, an ultra-capacitor, a high-speed charging section (140), is charged in a few seconds by simultaneously or progressively closing all switches inside the high-speed charging switch section (130) when all low-speed charging switch section (160) is opened. As soon as the ultra-capacitor is fully charged, all switches of high-speed charging switch section (130) is simultaneously or progressively opened while selectively closing at least one of the multiple low-speed charging switch inside the low-speed charging switch section (150). For example, when low-speed charging is completed from the first ultra-capacitor (UC1) to battery (170) by closing the first low-speed charging switch (151), the low-speed charging is performed from the second ultra-capacitor (UC2) to battery (170) by closing the second low-speed charging switch (152) and opening the first low-speed charging switch (151).

In the meantime, the battery charging apparatus according to the embodiment 1 of the present invention is installed in automobile using electricity as an energy source. Also, the battery charging apparatus according to the other embodiment of the present invention is installed in automobile using electricity as an energy source, including the remaining components other than charging section and rectifying section. Accordingly, the present invention helps minimize the charging time while maximizing the battery life by preventing the high-speed charging to the battery itself. In other words, a low-speed charging is performed from ultra-capacitor to the battery when the operating motor is stopped during a car drive.

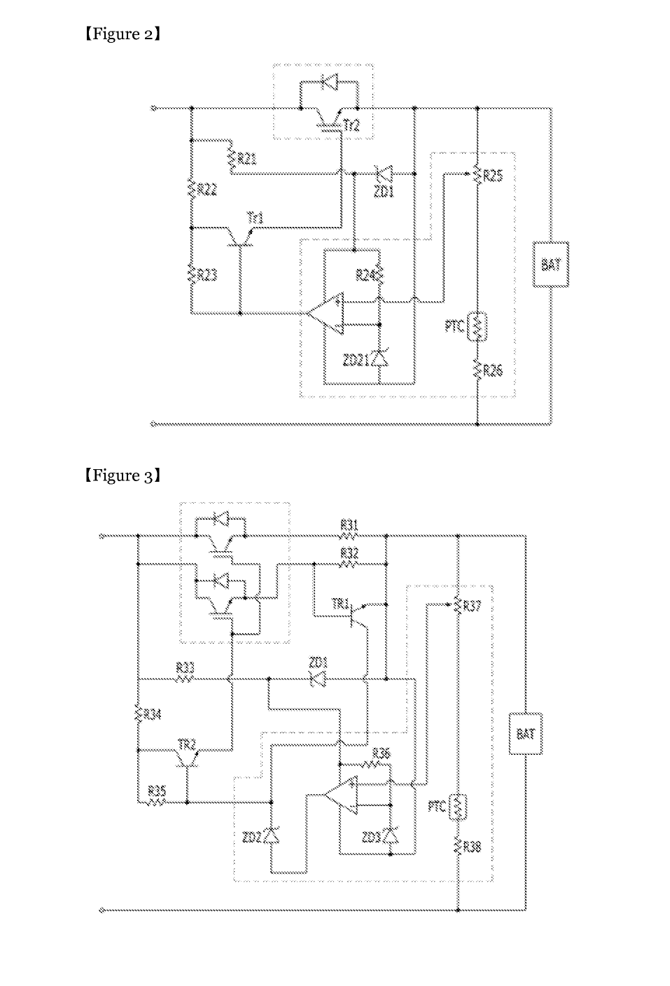

FIG. 2 is a detailed circuit diagram of the current control section among the battery charging apparatus according to the embodiment 2 of the present invention. Most of the constituents are the same as those of FIG. 1, except that the battery charging voltage detecting element includes more of the positive temperature coefficient (PTC). Due to the nature of the positive temperature coefficient, the resistance value decreases when temperature drops. Therefore, resistances (R23) connected in series and the combination resistance of the positive temperature coefficient decrease, causing the standard voltage authorized to the reversal terminal of the comparator. Meanwhile, self-discharge of battery is activated when outside temperature decreases. Therefore, even if voltages of the both sides of the switching element (IGBT) are the same, larger current needs to be flow through the switching element (IGBT) when the standard voltage authorized to the reversal terminal of the comparator is degreased.

FIG. 3 is a detailed circuit diagram of the current control section among the battery charging apparatus according to the embodiment 3 of the present invention. Most of the constituents are the same as those of FIG. 2, but more elaborated control of the slow-speed charging is possible by using multiple numbers of control switches (TR1, TR2).

As mentioned above, the technical ideas of the embodiments of the present invention may be embodied independently or in combination. Also, although the present invention is described in the limited embodiments and drawings, this invention may be modified in various ways by a person who has common knowledge in this field within the extent of the basic idea of the invention.

### DESCRIPTION OF SIGNS

110 . . . Voltage boosting section
120 . . . Rectifying section
130 . . . High-speed charging switch section
140 . . . High-speed charging section
150 . . . Low-speed charging switch section
160 . . . Charging current control section
170 . . . Low-speed charging section

1. A battery charging apparatus using ultra-capacitor, which is comprised of a high-speed charging switch section for high-speed charging;
an ultra-capacitor with the parallel connection to aforementioned high-speed charging switch section;
a low-speed charging switch section with the parallel connection to aforementioned ultra-capacitor;
a low-speed charging section with the parallel connection to aforementioned low-speed charging switch section

2. The battery charging apparatus using ultra-capacitor of claim 1, which is comprised of a voltage boosting section, which boosts three-phase prevailed voltage to fixed voltage;
a rectifying section, which rectifies AC voltage exported from aforementioned voltage boosting section into fixed level of DC voltage.

3. The battery charging apparatus using ultra-capacitor of claim 1,
wherein the high-speed charging switch section, which includes the multiple high-speed charging switches that are simultaneously or progressively on/off.

4. The battery charging apparatus using ultra-capacitor of claim 3,
wherein aforementioned multiple high-speed charging switches are all offed when aforementioned ultra-capacitor is fully charged.

5. The battery charging apparatus using ultra-capacitor of claim 4,
wherein aforementioned low-speed charging switch section includes multiple low-speed charging switches; aforementioned switches are same in the number with the high-speed charging switches; the low-speed charging switches are selectively switched.

6. The battery charging apparatus using ultra-capacitor of claim 5,
wherein aforementioned charging current control section includes low-speed charging voltage detecting element of parallel connection with aforementioned low-speed charging section; a switching element placed between aforementioned low-speed charging switch section and low-speed charging section; a battery charging voltage authorized to aforementioned low-speed charging voltage detecting element; a comparator comparing the standard voltage with the battery charging voltage received to the low-speed charging voltage detecting element; and a control switching element, which switches by the output of aforementioned comparator. Aforementioned switching element is controlled by the output of aforementioned control switching element.

7. The battery charging apparatus using ultra-capacitor of claim 6,
wherein aforementioned switching element is one of IGBT, FET, BJT or IGBT with parallel connection, FET with parallel connection, BJT with parallel connection.

8. The battery charging apparatus using ultra-capacitor of claim 6,
wherein aforementioned low-speed charging voltage detecting element preferably includes more positive temperature coefficients.

9. The electric automobile equipped with the battery charging apparatus using ultra-capacitor of claim 1.
